(19) United States
(12) Patent Application Publication
(10) Pub. No.: US 2021/0315771 A1
(43) Pub. Date: Oct. 14, 2021

(54) STEAM THERAPY APPARATUS

(71) Applicant: Vanessa White, Atlanta, GA (US)

(72) Inventor: Vanessa White, Atlanta, GA (US)

(21) Appl. No.: 16/846,491

(22) Filed: Apr. 13, 2020

(51) Int. Cl. A61H 33/06

(52) U.S. Cl. CPC A61H 33/065; A61H 2033/068; A61H 2205/087; A61H 2205/085; A61H 2201/0119

(57) ABSTRACT

A portable vaginal steamer is disclosed, comprising a reservoir to receive and retain at least one medicament and a volume of heated liquid. A rim portion forms a perimeter of the reservoir to at least partially support a user thereon to permit the user to squat over the reservoir and receive steam emitted from the liquid.

### TECHNICAL FIELD

The embodiments relate to steam therapy devices and, more specifically, relate to portable vaginal steaming devices.

### BACKGROUND

Vaginal steaming is an alternative health treatment whereby a woman squats or sits over steaming water containing various medicinal herbs such as mugwort, rosemary, wormwood, and basil. It has been reported that vaginal steaming may result in hormonal modulation and the revitalization of tissues.

Many primitive protocols have been used for thousands of years. In one example, the woman sits on a small, wood log with the woman's legs astride the log. A small pot of boiling water is placed between the legs adjacent to the small log. A blanket is then draped over the user to cover the patient and collect the steam emitted from the boiling water. These primitive systems do not properly dilate the skin pores, resulting in a limited detoxifying effect.

In the current arts, various heated reservoirs have been constructed to retain a volume of heated water and medicaments. The user may then squat over the reservoir which directs steam onto the user. These systems require the user to be flexible and strong enough to maintain a squatted position during treatment. In other iterations, the steaming mechanism is affixed to a shower, bathtub, or other permanent structure and is used as part of the normal bathing practices of the user. While effective, these implements may not be feasible for some.

### SUMMARY OF THE INVENTION

This summary is provided to introduce a variety of concepts in a simplified form that is further disclosed in the detailed description. This summary is not intended to identify key or essential inventive concepts of the claimed subject matter, nor is it intended for determining the scope of the claimed subject matter.

The present embodiments disclosed herein provide a portable vaginal steamer, comprising a reservoir to receive and retain at least one medicament and a volume of heated liquid. A rim portion forms a perimeter of the reservoir to at least partially support a user thereon to permit the user to squat over the reservoir and receive steam emitted from the liquid.

The embodiments provide a portable vaginal steamer which may be readily moved from storage to a treatment location. The steamer may be used on the floor or other surface and may also be releasably engaged with a toilet. The user may select a medicament to dispense into the reservoir before heated water is added to create a medicated steam.

In one aspect, the steamer comprises a bottom side having a protrusion extending from a perimeter of the rim portion, the protrusion to retain the steamer on the seat of a toilet.

In one aspect, the steamer comprises a bottom side having a protrusion extending from a perimeter of the rim portion, the protrusion to retain the steamer on the rim of a toilet.

In one aspect, the steamer comprises a heating element to heat the liquid.

In one aspect, the steamer is releasably engaged with the toilet.

In one aspect, a top side of the rim portion comprises a cushion.

During use, the user may utilize a flexible fabric to cover their body while trapping the steam emitted from the heated liquid. The flexible fabric may enhance the therapeutic effects of the steamer.

In one aspect, a microcontroller is in communication with a controller to permit the selection of operational settings. A power source may be provided within a housing of the steamer.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a perspective view of the portable vaginal steamer, according to some embodiments;

FIG. 2 illustrates a perspective view of the bottom side of the portable vaginal steamer, according to some embodiments;

FIG. 3 illustrates a perspective view of the portable vaginal steamer releasably engaged with a toilet, according to some embodiments;

FIG. 4 illustrates a perspective view of a user sitting atop the portable vaginal steamer, wherein the vaginal steam is positioned on the floor, according to some embodiments; and

FIG. 5 illustrates a perspective view of a user sitting atop the portable vaginal steamer, wherein the vaginal steam is positioned on a toilet, according to some embodiments.

### DETAILED DESCRIPTION

The specific details of the single embodiment or variety of embodiments described herein are to a system and method of use. Any specific details of the embodiments are used for demonstrative purposes only and no unnecessary limitations or inferences are to be understood therefrom.

Before describing in detail exemplary embodiments, it is noted that the embodiments reside primarily in combinations of components related to the system and method of use. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second”, “top” and bottom”, and the like, may be used solely to distinguish one entity or element from another entity or element without necessarily requiring or implying any physical or logical relationship or order between such entities or elements.

As used herein, the term “medicament” refers to various herbs, chemicals, medicine, liquids, oils, tinctures, or combinations thereof which may have therapeutic properties. Medicaments having medicinal properties which may be transmitted or enhanced via steam may be particularly useful.

As used herein, the term “liquid” may refer to any liquid which is disposed within the reservoir of the steamer. Most often, the liquid is water, although other liquids including polar and non-polar solvents are contemplated. The medicament does not need to be miscible in the liquid and may simply be mixed therein.

As used herein, the term “surface” refers to any surface upon which the steamer is placed during use. For example, the surface may be the floor, a chair, the rim of a toilet, the seat of a toilet, and the like.

In general, the embodiments described herein relate to a vaginal steaming system which is configured as a self-contained unit and which may be used directly on a surface (e.g. the floor or seat) in addition to being mountable to a toilet. The vaginal steaming system is comprised of a steamer having a heating element and a reservoir wherein medicaments are placed prior to receiving a volume of water within the reservoir. The heat of the water creates stream which is directed to the body of the user sitting overtop the steamer.

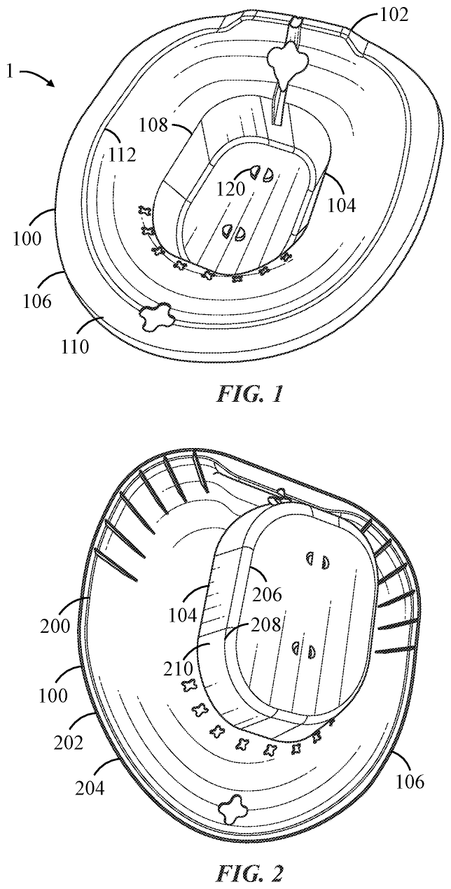

FIG. 1 illustrates the vaginal steaming system 1 including the steamer 100 comprised of a housing 102 formed as a reservoir 104 to receive a volume of hot liquid and a suitable amount of medicament. The steamer 100 includes a rim portion 106 integrally molded to the reservoir 104. The rim portion 106 is configured to be mounted to the rim or seat of a toilet to allow the rim portion 106 to rest on top of the toilet seat or rim during use. Alternatively, the steamer 100 may be positioned on a surface, such as the ground, with the rim portion 106 serving as a rest for the user's legs. The rim portion 106 defines the perimeter of the opening 108 of the reservoir 104 configured to emit steam through the opening 108.

In some embodiments, the housing 102 may contain one or more heating elements 120 to heat the liquid disposed within the reservoir 104. The heating elements 120 are in electrical communication with a power source to transmit sufficient energy to the heating element 120 to heat the liquid to a temperature sufficient to cause steam.

In some embodiments, the user disposes a hot liquid into the reservoir prior to steaming. The hot liquid is retained within the reservoir throughout the steaming process.

In some embodiments, a top side 110 of the rim portion 106 comprises a cushion 112 to provide comfort during long periods of sitting on the steamer 100.

FIG. 2 illustrates the bottom side 200 of the steamer 100. The perimeter 202 of the rim portion 106 is molded to form a protrusion 204 to retain the steamer 100 in position when positioned on top of a toilet rim or seat. A base 206 is provided on the bottom side 200 of the reservoir 104 to allow the steamer 100 to stand on a surface.

In some embodiments, the steamer 100 may comprise a drain to permit drainage of the liquid and medicaments after their use. In an alternative embodiment, the rim portion 106 may be formed to include a spout to direct the flow of liquid during drainage.

In some embodiments, the reservoir 104 has a height 208 defined by the sidewall 210 to permit the reception of the medicament and the liquid without touching the water within the toilet bowl.

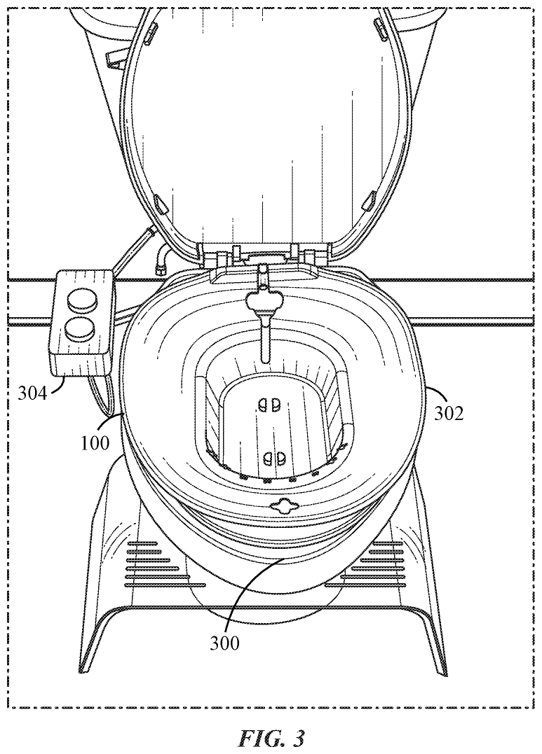

FIG. 3 illustrates the steamer 100 positioned on top of the rim 300 of a toilet 302. The reservoir 104 extends into the bowl of the toilet 302 with the rim portion 106 extending over the toilet rim 300 to permit the user to sit thereon. The steamer 100 may be provided as a standalone unit and is easily portable by lifting the steamer 100 from the toilet for drainage, cleaning, and/or when not in use. Steamer 100 may comprise one or more controllers 304 to allow for the modulation of the liquid temperature, to turn the heating elements 120 on, or similar functions.

In some embodiments, the power source and controller 304 may be in communication with a microprocessor to execute various instructions stored in a memory. The instructions may include operating procedures including heating temperatures and timer settings. In such, the user may program or engage with preprogrammed settings to change the temperature of the heating elements 120 and time during which steam is emitted.

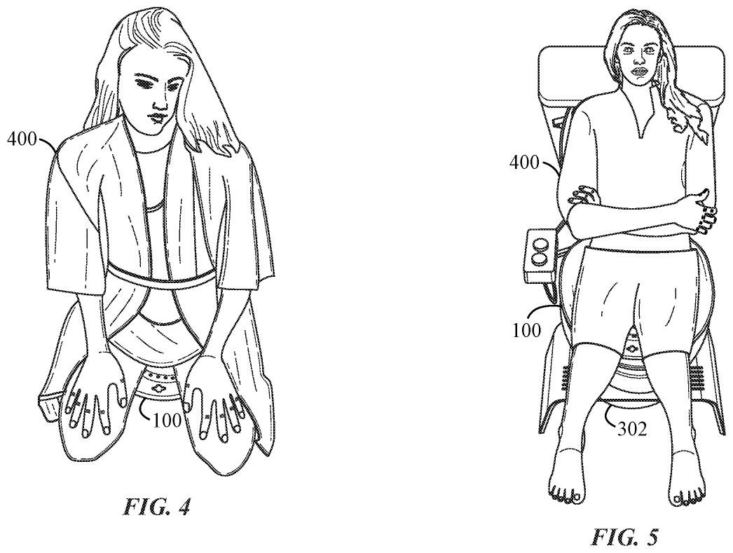

FIG. 4 illustrates the user 400 positioned over the steamer 100 wherein the steamer is positioned on the ground. The user 400 squats over the steamer 100 to receive the steam emitted therefrom. FIG. 5 illustrates the user 400 positioned in a seated position on a toilet 302 having the steamer 100 positioned thereon. The user 400 sits over the steamer 100 to receive the steam emitted therefrom. During use, the user 400 may benefit from wearing a skirt, dress, towel, or other flexible material to cover the body and trap the steam emitted from the steamer 100.

To prepare the steamer 100 for use, a medicament is disposed into the reservoir 104 of the steamer 100. The reservoir 104 is then filled with a liquid which may be preheated or is heated by the heating element within the reservoir 104. The user 400 then positions the steamer 100 on a surface (e.g., the floor, a chair, or on a toilet seat or rim) and lowers the body on top of the steamer to receive the steam emitted from the reservoir. Once steam is no longer emitted from the reservoir 104 or following a period of steam therapy, the user 400 drains the liquid and medicament from the reservoir 104 and cleans the steamer 100 prior to storage between uses.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A portable vaginal steamer, comprising:
a reservoir to receive and retain at least one medicament and a volume of heated liquid; and
a rim portion forming a perimeter of the reservoir, the rim portion to at least partially support a user thereon to permit the user to squat over the reservoir and receive steam emitted from the liquid.

2. The portable vaginal steamer of claim 1, wherein the steamer comprises a bottom side having a protrusion extending from a perimeter of the rim portion, the protrusion to retain the steamer on the seat of a toilet.

3. The portable vaginal steamer of claim 1, wherein a base is provided on a bottom side of the reservoir to allow the steamer to stand on a surface.

4. The portable vaginal steamer of claim 1, wherein the steamer comprises a heating element to heat the liquid.

5. The portable vaginal steamer of claim 1, wherein the steamer is releasably engaged with the toilet.

6. The portable vaginal steamer of claim 1, wherein a top side of the rim portion comprises a cushion.

7. A portable vaginal steamer, comprising:
a reservoir to receive and retain at least one medicament and a volume of heated liquid, the reservoir having a height sufficient to receive the volume of heated liquid without touching the water in a toilet; and
a rim portion forming a perimeter of the reservoir, the rim portion to at least partially support a user thereon to permit the user to squat over the reservoir and receive steam emitted from the liquid.

8. The portable vaginal steamer of claim 7, further comprising a microcontroller in communication with a controller to permit the selection of operational settings.

9. The portable vaginal steamer of claim 8, further comprising a power source in electrical communication with the microcontroller and the controller to permit the steamer to be a self-contained system.

10. The portable vaginal steamer of claim 9, wherein the steamer comprises a bottom side having a protrusion extending from a perimeter of the rim portion, the protrusion to retain the steamer on the seat of a toilet.

11. The portable vaginal steamer of claim 9, wherein a base is provided on a bottom side of the reservoir to allow the steamer to stand on a surface.

12. The portable vaginal steamer of claim 10, wherein the steamer comprises a heating element to heat the liquid.

13. The portable vaginal steamer of claim 11, wherein the steamer is releasably engaged with the toilet.

14. The portable vaginal steamer of claim 12, wherein a top side of the rim portion comprises a cushion.

15. A portable vaginal steaming system, comprising:
a reservoir to receive and retain at least one medicament and a volume of heated liquid;
a rim portion forming a perimeter of the reservoir, the rim portion to at least partially support a user thereon to permit the user to squat over the reservoir and receive steam emitted from the liquid,
wherein a user disposes the medicament and the volume of liquid within the reservoir, wherein the reservoir is positioned on a surface, and wherein the user positions their body over the reservoir to receive the steam emitted from the liquid and medicament.

16. The portable vaginal steamer of claim 15, wherein the steamer comprises a bottom side having a protrusion extending from a perimeter of the rim portion, the protrusion to retain the steamer on the seat of a toilet.

17. The portable vaginal steamer of claim 16, wherein a base is provided on a bottom side of the reservoir to allow the steamer to stand on a surface.

18. The portable vaginal steamer of claim 17, wherein the steamer comprises a heating element to heat the liquid.

19. The portable vaginal steamer of claim 18, wherein the steamer is releasably engaged with the toilet.

20. The portable vaginal steamer of claim 19, wherein the medicament includes at least one of the following: at least one herb, at least one medicine, and at least one chemical.
